(19) United States
(12) Patent Application Publication
(10) Pub. No.: US 2006/0225793 A1
(43) Pub. Date: Oct. 12, 2006

(54) Method and apparatus for dosing inhibitors

(75) Inventors: Bjarne Olsen, Oslo (NO); Terje Sontvedt, Gjettum (NO)

Correspondence Address: SIERRA PATENT GROUP, LTD., 1657 Hwy 395, Suite 202, Minden, NV, 89423, US

(73) Assignee: Weir Norge A.S., a Norwegian Corporation

(21) Appl. No.: 11/130,581

(22) Filed: May 16, 2005

(30) Foreign Application Priority Data
Apr. 11, 2005 (NO) 2005 1778

(51) Int. Cl. F16K 11/02

(52) U.S. Cl. 137/605

(57) ABSTRACT

Valve, especially for dosing inhibitors to prevent forming of hydrates in the exploration of oil and gas, or as a liquid choke. The inhibitor or liquid has a first and higher pressure upstream of the valve and a second and lower pressure downstream of the valve. The valve has a valve body with at least one orifice therethrough. The orifice has a substantially uniform diameter and an upstream inlet part. The inlet part has an enlarged diameter relative to the substantially uniform diameter of the orifice. The valve body is disc shaped with a plurality of parallel orifices placed equidistant from a rotational axis.

### PRIORITY CLAIM

This application claims priority to Norwegian Patent Application No. 2005 1778, filed on Apr. 11, 2005, which is explicitly incorporated by reference as if set forth below.

### FIELD OF THE INVENTION

The present invention relates to a valve for dosing inhibitors into a flow channel. The invention also relates to a method for flow control for dosing inhibitors into the flow channel.

Problem

Inhibitors are added to the injection lines of petroleum wells or to flowlines to prevent forming of hydrates. One type of inhibitor that is commonly used is monoethylene glycol (MEG). However, also other types of inhibitors are occasionally added, preferably containing alcohols, glycols, and/or salts.

Protection of the production system requires a minimum ratio of MEG in the water. Full scale and laboratory investigations with, e.g., MEG as inhibitor shows that hydrate blockages form more readily in under-inhibited systems than in systems without addition of any inhibitor. Under-inhibition will lead to hydrate formation and can therefore not be tolerated. It is therefore a requirement of the MEG supply system to provide the required amount or slightly more than required amount of MEG.

Some of a plurality of wells that are connected to a common system may exhibit a much less pressure than the MEG supply system. It is therefore a need for a valve that will deliver the required amount to each well, depending on the water fraction in the production flow and the pressure difference. Thus for any given pressure difference between a well and the supply of MEG the correct flow rate of MEG is determined by selection of the correct orifice diameter in the valve.

The relations between the flow rate and the corresponding pressure loss for a selected orifice diameters form the basis for dosing MEG with a rotating gate valve.

Several orifice diameters and lengths have been tested to make accurate correlations that can be used for all relevant pressure differences, orifice diameters and up to 200 m³/day of MEG.

For example: 3, 4, 4.8, 5.4, 6 and 10 mm orifices have to deliver the intended flow rate of 90% MEG 0-180 m³/day for all relevant pressure drops (20-145 bar) between the supply line and the wellheads. The supply pressure is set to 275 bar. The 10 mm orifice has to deliver large flow rates at small pressure differences (calculated to 325 m³/day at 20 bar pressure difference) in order to flush the valve.

With high pressure differences the liquid velocity in the orifice can be high (in the magnitude of 120 m/s). Further, small solids (e.g. fines) may be present in the liquid. High velocity tests with and without solid particles have demonstrated that materials can be selected to achieve satisfactory corrosion and erosion properties for long term operation.

Furthermore, the flow may cavitate either inside the orifice or immediately after exiting the orifice. Cavitation of the chemical inside the bore will lead to damages of the internal bore of the orifice and to equipment downstream of the orifice. Cavitation tests with ordinary angular entrance to the orifice have shown that for example with a required pressure difference of 145 bar (inlet pressure 275 bar) as little as an increase to 155 bar pressure difference has induced cavitation. Consequently, the current dosage orifices are operating on the border of possible operation and strict limitations apply on maximum pressure drop in relation to flow rate and type of chemical.

A possible solution to the cavitation problem is to arrange the pressure drop in two stages. However, this requires more space, which is not always available (E.g. in a sub-sea valve tree arrangement).

Solution

Thus, a main objective of the present invention is to provide a dosage valve that can take a higher pressure difference in one step without the risk of cavitation of the inhibitor. This is achieved with an inlet part that has an enlarged diameter relative to the substantially uniform diameter of the orifice.

This type of orifice can also be used in a choke valve for liquids.

Preferably, the inlet part is rounded, parabolic or chamfered, as this provides a smooth transition to the smaller diameter of the orifice.

Good results are achieved by an inlet part that has a largest inlet diameter at least 20% greater than the smallest diameter of the orifice.

If the ratio between the smallest diameter of the orifice and the diameter of an inlet pipe or an outlet pipe, the inlet pipe or the outlet pipe transporting fluid to and from the orifice, is between 0,05 and 0,17, a required flow capacity is achieved.

If the inlet part has a largest diameter about twice the smallest diameter of the orifice the performance of the orifice is even further improved.

If the length of the inlet part is about half the diameter of the orifice the performance of the orifice will be at an optimum.

A further aspect of the present invention has the object to provide a valve that facilitates the adjustment of flow. This is achieved by a valve body having a plurality of parallel orifices.

Preferably, the valve body is disc shaped and rotatable about an axis transverse to the plane of the disc, and the plurality of orifices are distributed equidistant from the axis of rotation, so that a selected orifice can be rotated into a flow channel for the inhibitor. Thereby the active orifice can easily be changed to adjust the flow.

Preferably, for a MEG dosage application, the plurality of orifices range from a diameter of about 3 mm to a diameter of about 10 mm. This will cover the most important range of flows.

If at least two orifices are adapted to be placed in parallel or in series in the flow, it will provide a further means for adjusting the flow. This will also provide a possibility for finer adjustment of the flow rate.

It has been found that the ratio between the length of the orifice and the diameter of the orifice preferably should be between 8 and 30, as this provides the required flow reduction.

The invention also provides a method for flow control through an orifice, especially for dosing inhibitors to prevent forming of hydrates in the exploration of oil and gas. The method reduces the risk of cavitation by forming the inlet of the orifice with an enlarged diameter relative to the remaining part of the orifice. Then the pressure drop immediately after the inlet is avoided and a lowest pressure occurs at the outlet of the orifice.

Preferably this is achieved by forming the inlet with a parabolic shape. This has proved to result in very good performances.

By rounding or chamfering the entrance of the orifice, which is a small change of the design of the orifice, it has been found that the operating envelope with respect to cavitation can be largely increased. For example the limit found for angular entrance can be increased from 155 bar pressure difference to more than 200 bar. The large operating envelope caused by these results represents new knowledge.

Of importance is also that the experiments show that for all diameters of orifice tested, the rounding of the entrance of the orifice lead to an increase of flow rate of 20-30% over the entire range of pressure differences.

The present invention results in one or more of the following advantages:

Less risk of cavitation at extreme pressure differences.

Increased flow rate for a given pressure differential.

Reduced erosion by solids.

The orifice material can tolerate a velocity range of MEG through the orifice ranging from 40-150 ml/s.

It has also been found, despite what was to be expected by an orifice with a larger inlet than the downstream diameter, that sand particles do not bridge the entrance of the orifice. Tests show that no bridging of particles occurred at the entrance. Test have also been done in which iron carbonate (Fe₂CO₃) was deliberately deposited on the orifice walls to simulate deposition of relevant chemical substances. Normal flow through the orifice removed the iron carbonate.

These and other results of the tests will be shown and explained in the following.

### BRIEF DESCRIPTION OF THE DRAWINGS

The invention will be explained in detail referring to the appending drawings, in which:

FIG. 1 shows a simple pressure reduction unit for test purposes, having an orifice according to the prior art,

FIGS. 2a-2c show a disc having a plurality of orifices with varying diameter,

FIGS. 3a-3b show a dosage valve with actuator in side view and front view,

FIG. 4 shows schematically a longitudinal section through an orifice,

FIG. 5 shows schematically a part of the entrance of the orifice in a preferred embodiment,

FIG. 6 shows schematically a longitudinal section through the orifice and the pressure recording positions,

FIG. 7a shows a schematic longitudinal section though an angular orifice and the area of the lowest pressure,

FIG. 7b shows a similar schematic longitudinal section though a parabolic orifice as FIG. 7a,

FIG. 8 shows a graph of the pressure distribution along orifices with different inlet parts,

FIG. 9a shows a graph of the flow capacity of orifices with a diameter of 4 mm,

FIG. 9b shows a similar graph as FIG. 9a for a 6 mm orifice,

FIG. 10 shows graphs of flow v. pressure drop for different diameters of orifices with parabolic inlet part,

FIG. 11a shows graphs of the inlet pressure v. limiting pressure drop before cavitation occurs for orifices with a diameter of 3 mm and different inlet parts,

FIG. 11b shows graphs similar to FIG. 11a for 4 mm orifices, and

FIG. 11c shows graphs similar to FIG. 11a for 4.8 mm orifices.

### DETAILED DESCRIPTION

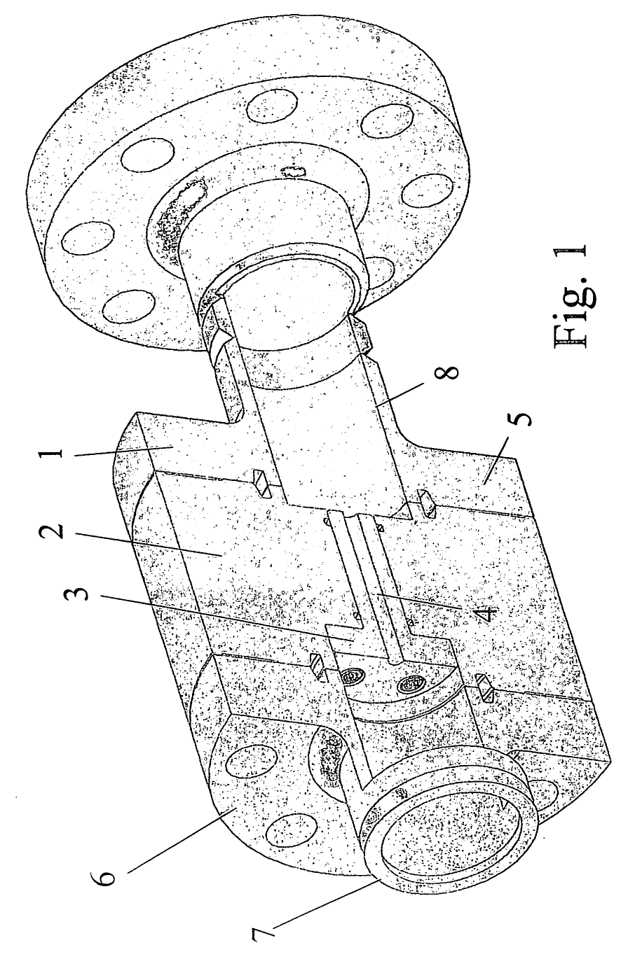

FIG. 1 shows a pressure reduction unit 1 for test purposes. It includes an orifice section 2, having an orifice insert 3 with an orifice 4 there through. At either end of the orifice section 2 a flange 5, 6 is connected, coupling an inlet pipe 7 and an outlet pipe 8 to the orifice section 2.

The orifice insert 3 can easily be exchanged with another insert having an orifice with a different diameter.

Radial ports (not shown) have been formed through the orifice section 2 and insert 3, for connection of pressure sensors (not shown).

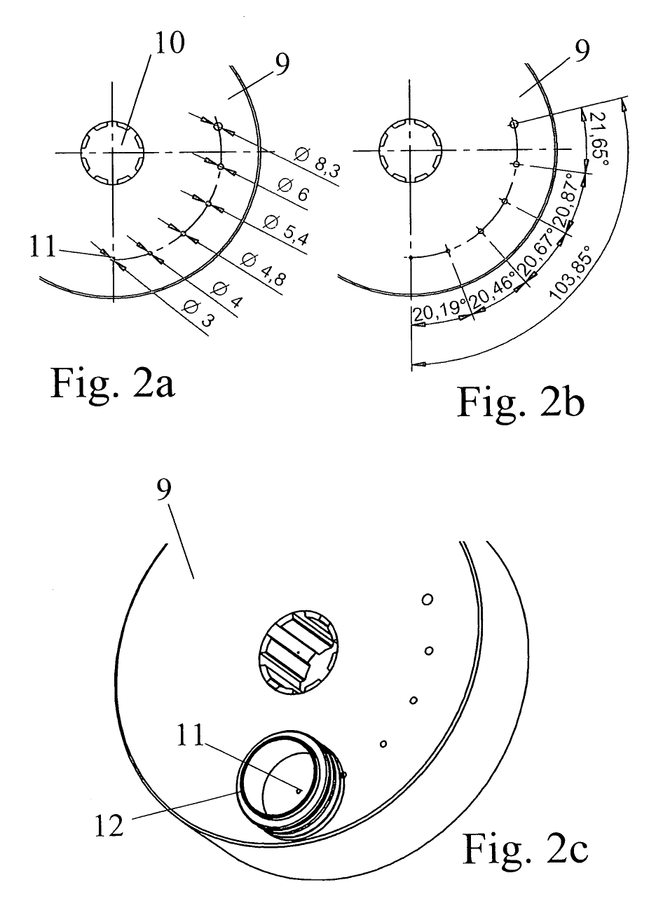

FIGS. 2a-c show a disc 9 for use as a valve body in a dosage valve. The disc has a center hole 10, about which the disc may rotate. At a distance from the center hole 10 are a plurality of orifices 11 of different apertures, ranging from 3 mm to 8,3 mm. The orifices are placed equidistant from the center hole 10.

FIG. 2c shows a pipe insert 12 positioned relative to the disc 9. The pipe insert represents the flow channel of the inhibitor. The disc 9 may be rotated to place a selected orifice 11 centrally in the flow channel. The angular distances between the orifices 11 (see FIG. 2b) are chosen so that when the disc 9 is rotated to position another orifice in the flow channel, the orifice will be situated at a predetermined position within the flow channel.

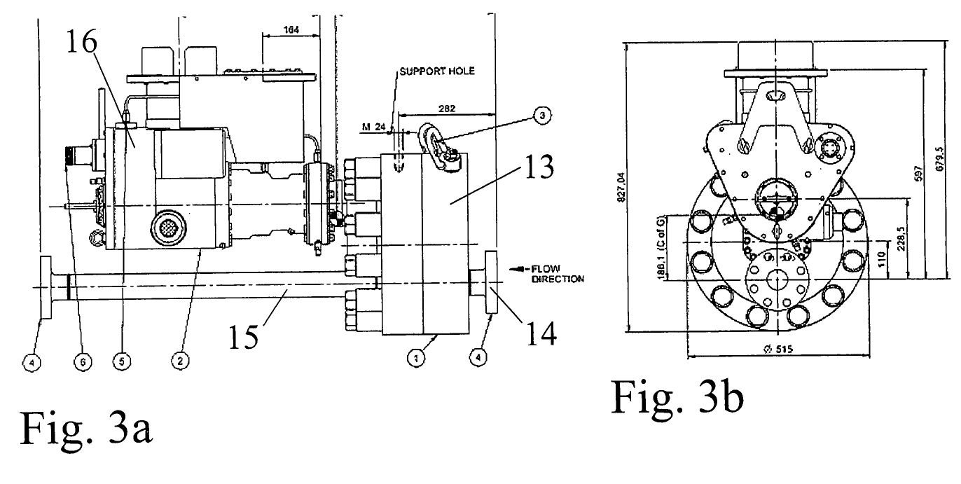

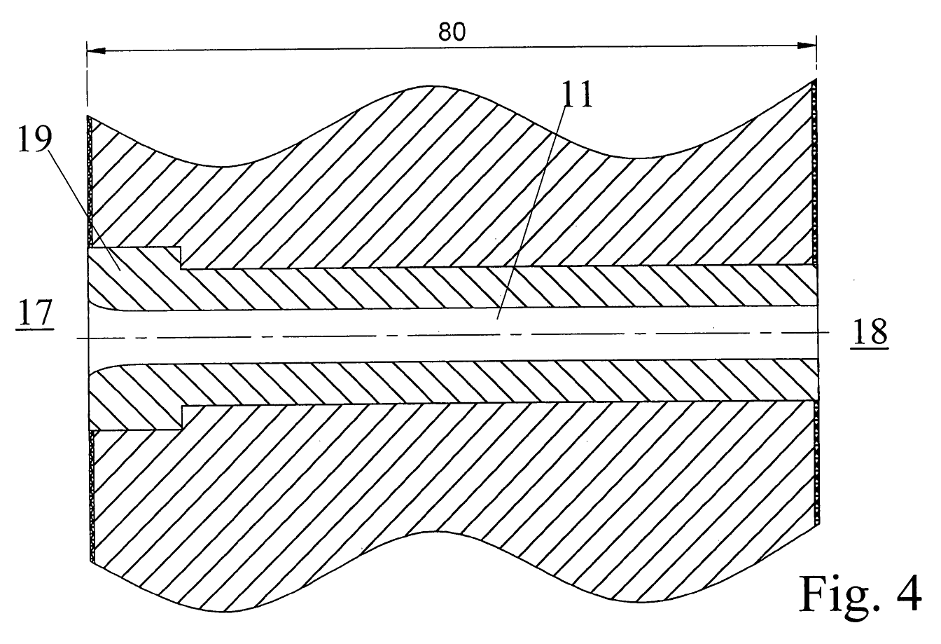

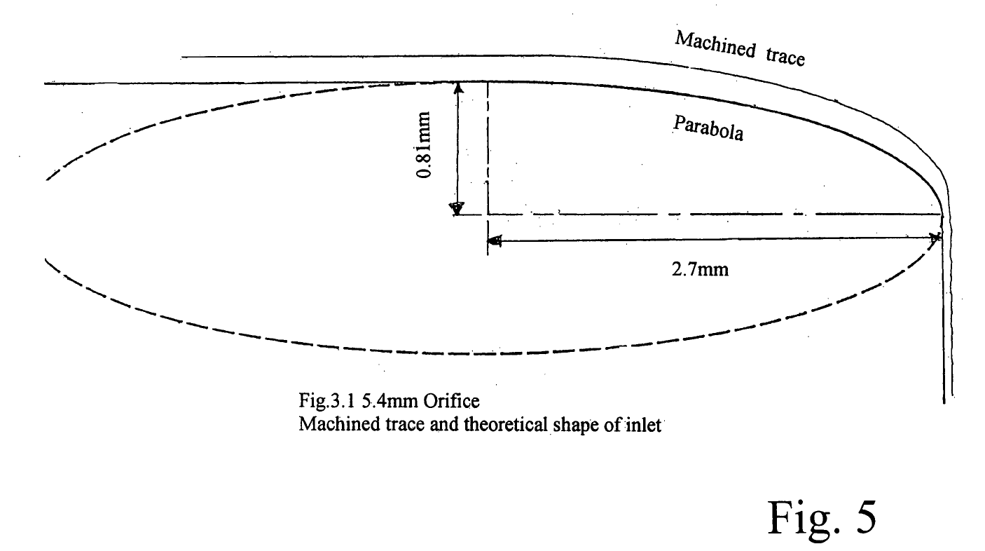

FIGS. 3a-b shows a dosage valve having a valve house 13 containing a disc 9 according to FIGS. 2a-c. An inflow line 14 is connected to the valve house 13 at one side, and an outflow line 15 is connected to the house 13 at an opposite side. An actuator 16 is connected to the housing 13 and is operatively coupled to the disc 9 to rotate this.

FIG. 4 shows schematically a longitudinal section through an orifice 11. Upstream of the orifice 11 is an inlet pipe 17 and downstream of the orifice 11 is an outlet pipe 18. The orifice is protected by an insert 19 made of solid tungsten carbide (STC) with 10% Co as binder.

FIG. 5 shows a longitudinal section through a preferred shape of the inlet area of the orifice 11 in FIG. 4. The diameter of the orifice is in this example is 5.4 mm. As can be seen from the drawing the achieved machined profile of the inlet area of the orifice resembles a parabola.

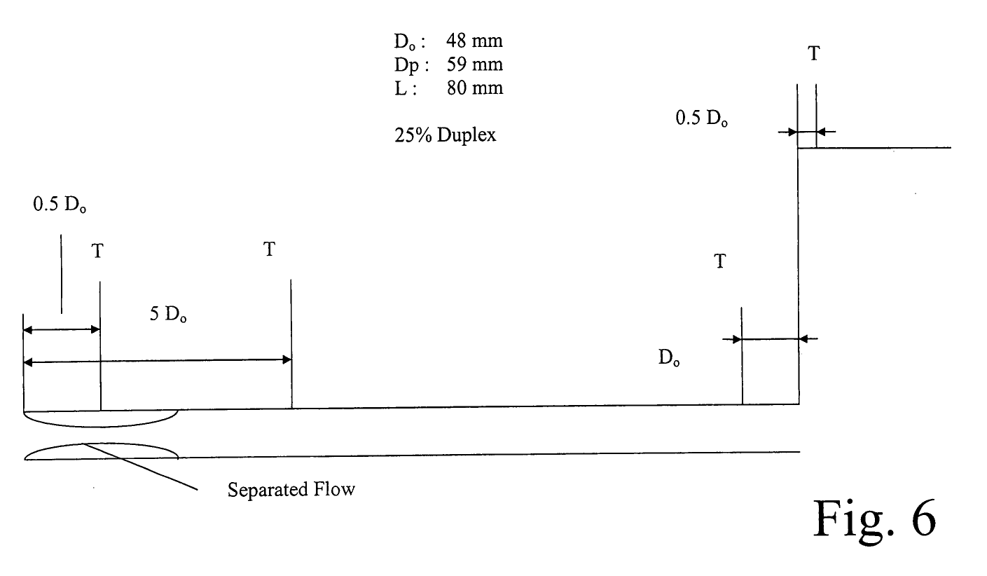

FIG. 6 shows the positions of pressure transducers during a test procedure. The transducers were placed as follows (Dₒ denotes the nominal diameter of the orifice):

1×Dₚᵢₚₑ upstream orifice

0.5×Dₒ from Leading edge

1×Dₒ from Leading edge

1×Dₒ from Trailing edge

0.5 Dₒ downstream Trailing edge

10×Dₚᵢₚₑ downstream Trailing edge

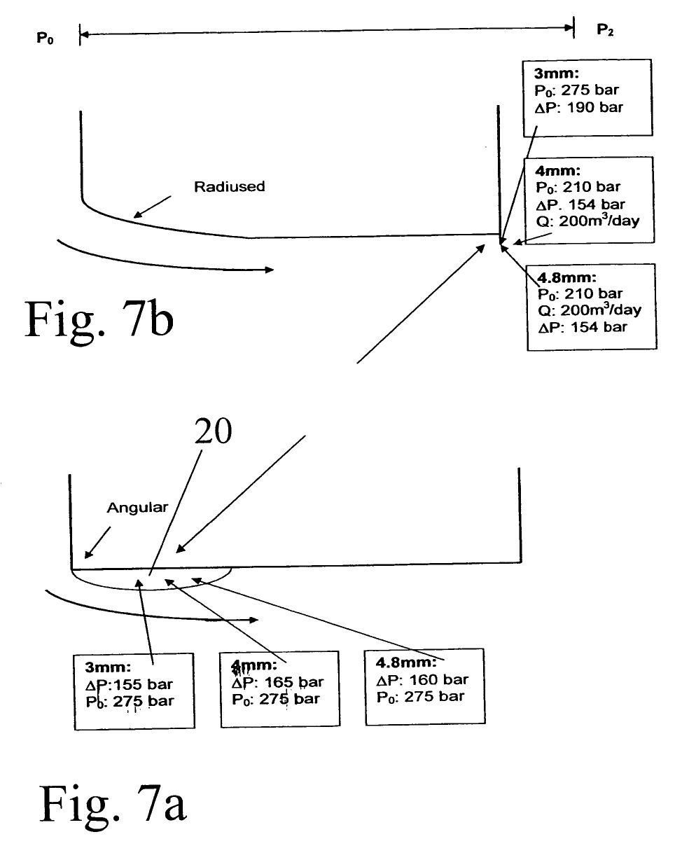

FIGS. 7a and b show a diagram of pressure measurements made by the transducer configuration of FIG. 6. FIG. 7a shows an orifice with an angular inlet. The minimum pressure (or maximum pressure drop) of the fluid flowing through the length of this orifice occurs shortly downstream of the inlet in an area 20 close to the wall of the orifice. The pressure on the upstream side of the orifice is 275 bar. For a 3 mm orifice the pressure drop at which the fluid starts to cavitate is 155 bar, for a 4 mm orifice the pressure drop at cavitation is 165 bar and for a 4,8 mm orifice the pressure drop at cavitation is 160 bar.

The area 20 creates a constriction of the effective cross section for flow. This reduces the flow area through the orifice and increases the velocity of the fluid. The increased velocity results in a lower pressure also outside the area 20. The reduced pressure makes this section prone to cavitation if the inlet pressure is low.

FIG. 7b shows an orifice with a parabolic inlet. Here the minimum pressure (or maximum pressure drop) occurs at the outlet of the orifice. Also here the pressure on the upstream side of the orifice is 275 bar. For a 3 mm orifice the pressure drop at which the fluid starts to cavitate is 190 bar. For a 4 mm orifice the pressure upstream of the orifice had to be reduced to 210 bar to create a situation where the fluid was in risk of cavitating. This resulted in a pressure drop at cavitation of 154 bar at the upstream side of the orifice. For a 4,8 mm orifice the pressure at the upstream side also had to be reduced to 210 bar to cavitate. This resulted in a pressure drop at cavitation of 154 bar.

Consequently, a substantially increased pressure drop before cavitation for the 3 mm orifice is achieved. For the 4 mm and 4,8 mm orifices it was hard to get the fluid to cavitate and the inlet pressure had to be reduced to obtain cavitation. Even more important is that the minimum pressure does no longer occur immediately downstream of the inlet. The effective cross section thus becomes approximately the same throughout the length of the orifice. As a result, the erosion of the orifice by solids in the flow is reduced.

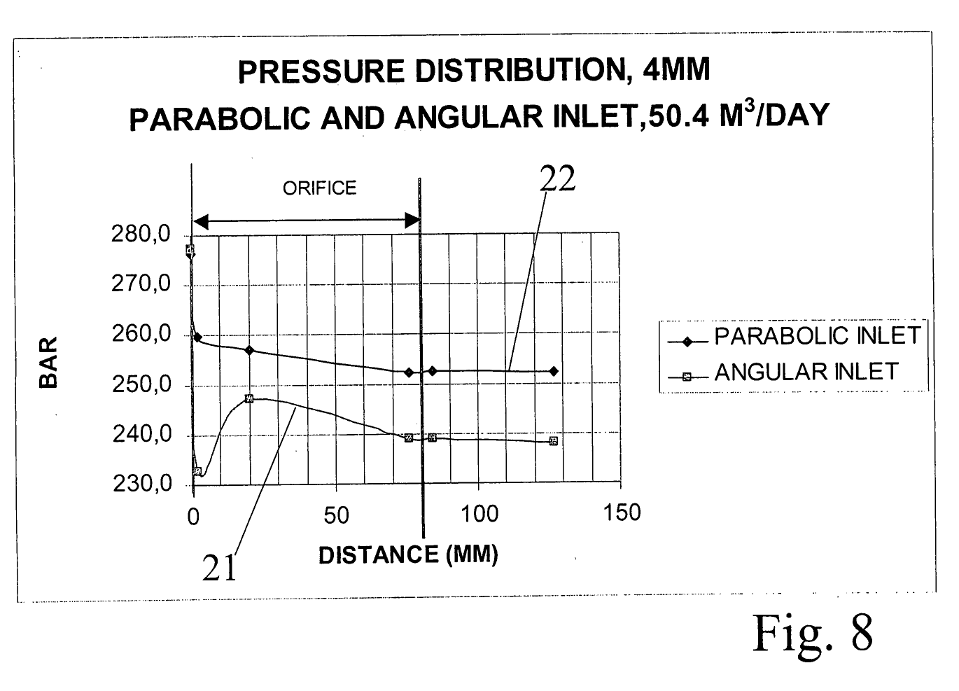

FIG. 8 shows a diagram of the pressure distribution along the length of a 4 mm orifice. The graph 21 shows the pressure distribution for an orifice with an angular inlet and the graph 22 shows the pressure distribution for an orifice with a parabolic inlet.

The graph 21 shows that a local pressure drop occurs immediately downstream of the angular inlet. Further downstream the pressure increases again and from about 20 mm from the inlet to the outlet the pressure gradually decreases.

On the other hand, the graph 22 shows that in an orifice with parabolic inlet, the pressure drop is moderate downstream of the inlet and from this point the pressure gradually decreases to the outlet. The pressure at the outlet is higher than for an orifice with angular inlet. Consequently, the pressure difference for the same flow rate is less for a parabolic inlet compared with an angular inlet.

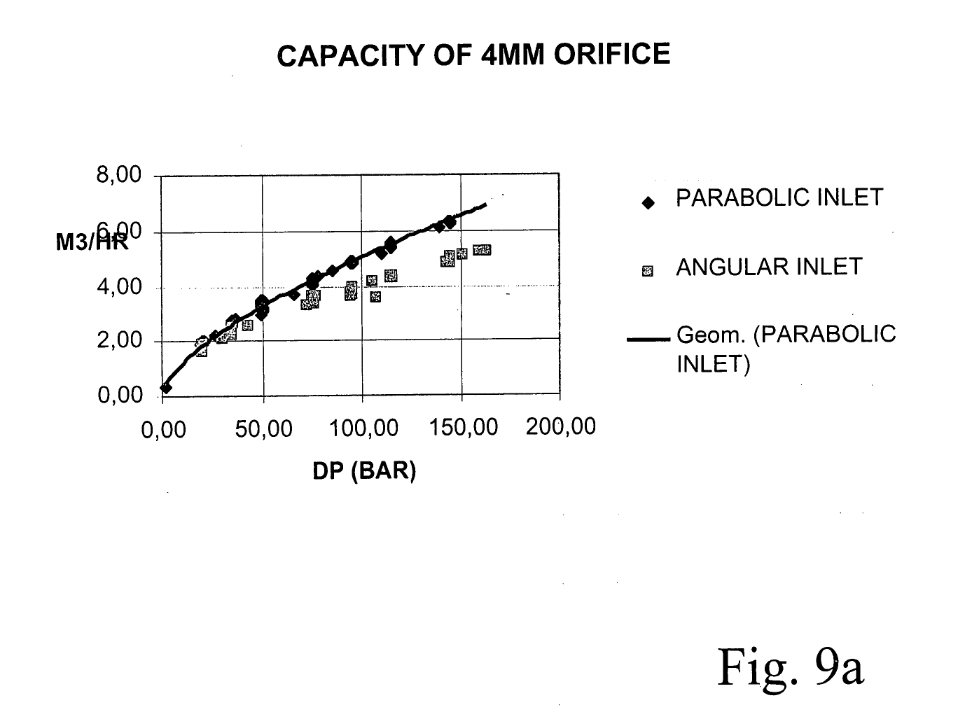

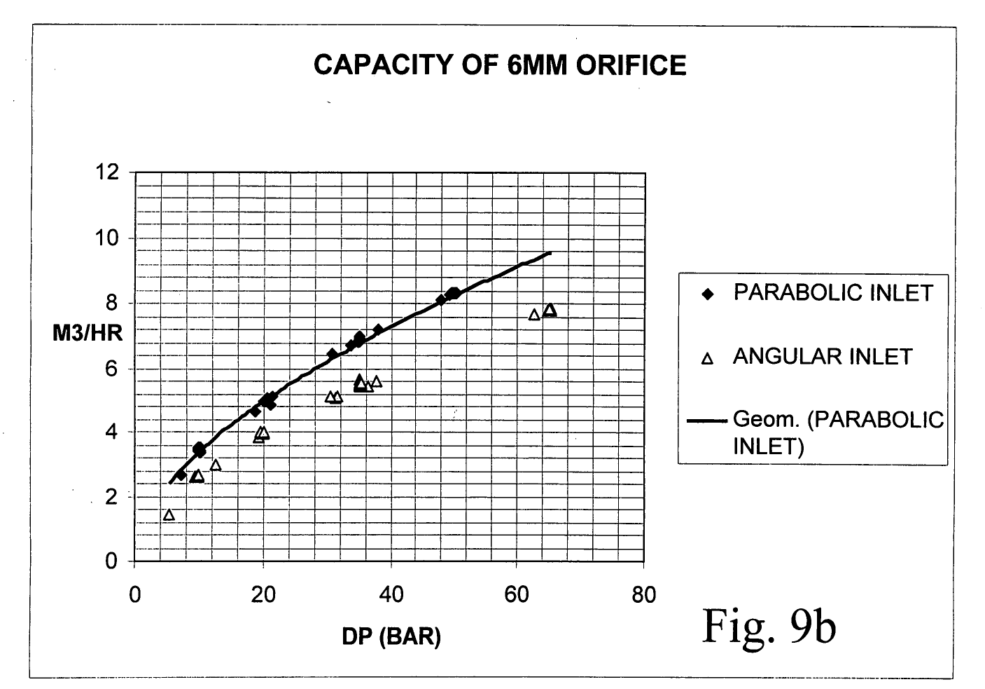

FIGS. 9a and 9b show diagrams of the pressure drop over the orifice versus the flow rate (m³/hour) through a 4 mm and a 6 mm orifice, respectively. The square shapes (FIG. 9a) and the triangular shapes (FIG. 9b) represent an orifice with angular inlet and the diamond shapes represents an orifice with parabolic inlet.

As is evident from FIGS. 9a and 9b the orifice with parabolic inlet results in a much higher flow at the same pressure differential relative to the orifice with angular inlet. This is true for all flow rates and pressure differentials within the target range of the present invention. An orifice with parabolic inlet exhibits a much higher flow versus pressure drop for all orifices within a tested range of orifices from 3 mm to 10 mm.

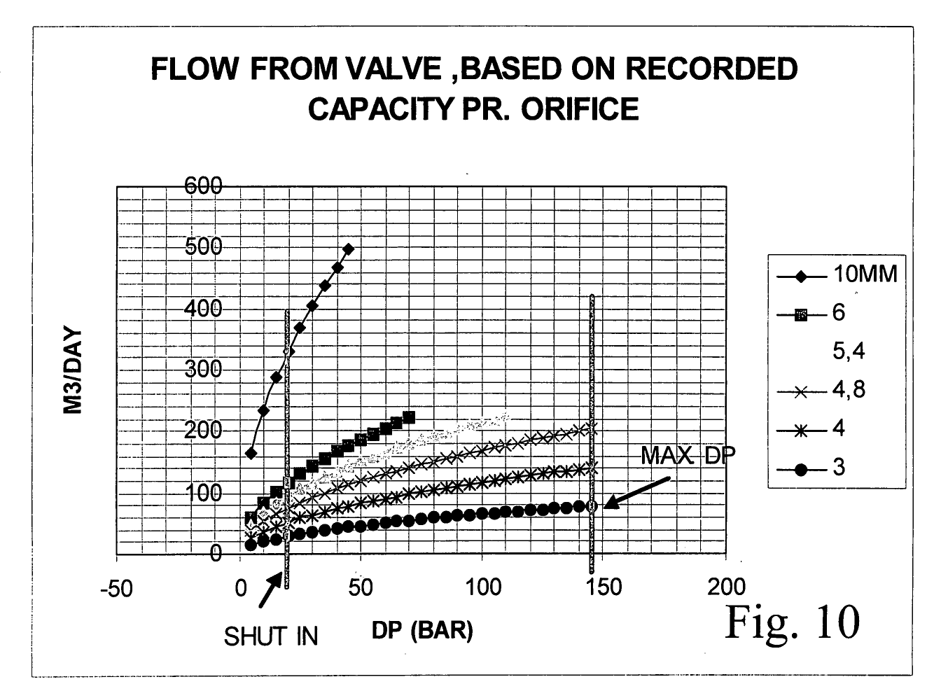

FIG. 10 shows graphically the results of a flow test made on different orifice diameters ranging from 3 mm to 10 mm. On the vertical axis is the amount of fluid flowing through the orifice in m³/day. On the horizontal axis is the differential pressure across the orifice in bar. As can be seen from this diagram the smaller the diameter of the orifice, the lesser the flow rate will be for the same pressure differential.

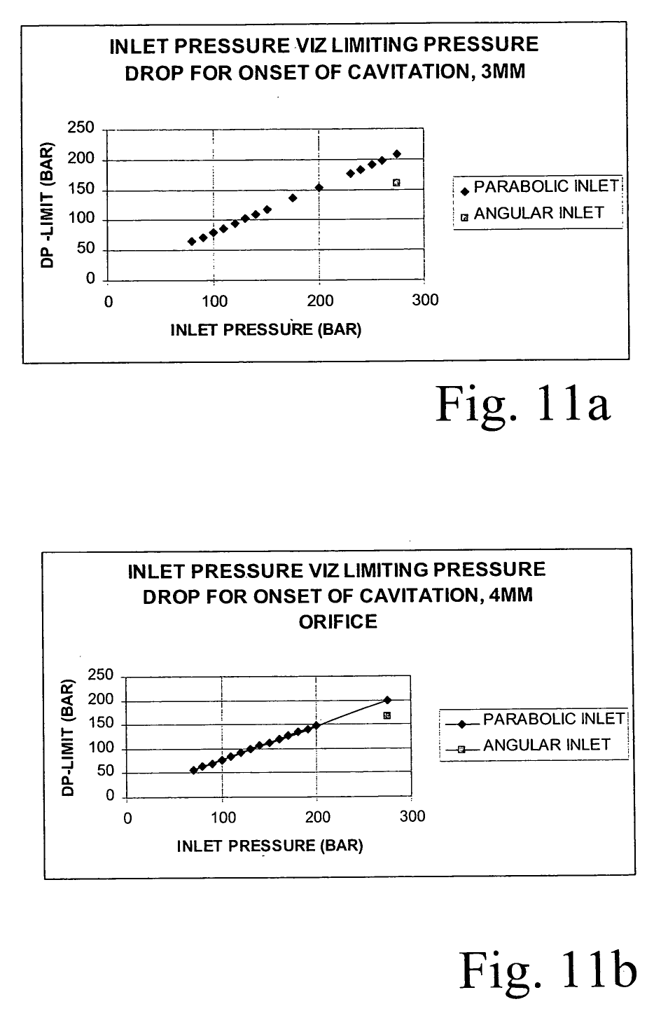

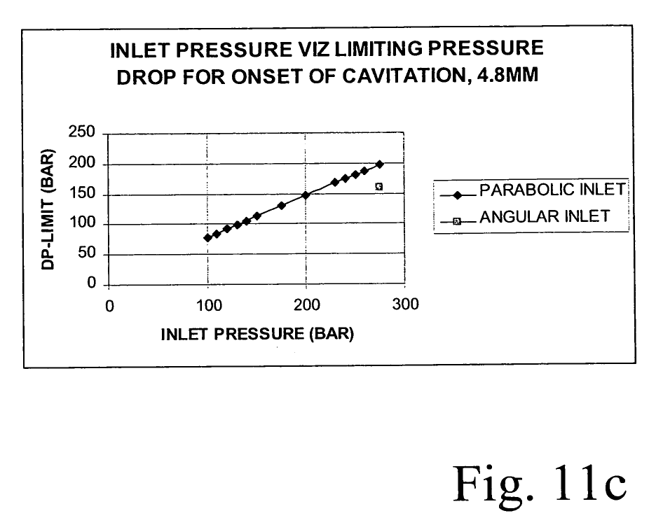

FIGS. 11a-11c show diagrams of test results where the inlet pressure of the orifice has been increased until the fluid cavitates. In all figures the diamond shapes represent parabolic inlet and the square shape (light gray) represents one measure for an angular inlet. FIG. 11a shows a 3 mm orifice, FIG. 11b a 4 mm orifice and FIG. 11c a 4,8 mm orifice. The horizontal axis is the pressure upstream of the orifice and the vertical axis is the pressure drop where cavitation occurs.

As is evident from FIGS. 11a-11c the orifices with parabolic inlet will manage a much higher pressure drop before cavitation.

Table 1 below is an example of orifice diameters (diameter of the cylindrical part of the orifice) and their corresponding dimensions of the inlet part (Distance from inlet to the cylindrical part and the largest diameter of the orifice at the inlet):

TABLE 1
Radiused Inlet-Profiles with gradual contraction

| | Dia. orifice | | |
|---|---|---|---|
| | cylindrical | Distance to cylindrical | Dia. orifice inlet |
| Hole No. | part (mm) | part from inlet (mm) | (mm) |
| 1 | 3 | 1.5 | 3.9 |
| 2 | 4 | 2 | 5.2 |
| 3 | 4.8 | 2.4 | 6.24 |
| 4 | 5.4 | 2.7 | 7.02 |
| 5 | 6 | 3 | 7.8 |
| 6 | 7 | 3.5 | 9.1 |

As can be seen from Table 1 the largest diameter at the inlet is more than twice the diameter of the cylindrical part of the orifice. The largest diameter should be at least 20% greater than the cylindrical part.

The 3, 4 and 4.8 mm orifices cover the total well pressure range and predicted flow rate from 20 to 173 m3/day.

The 5.4, 6 and 10 mm cover larger flow rates at moderate pressure drops. Downstream pressures larger than the shut in pressure were introduced to make a more complete flow-pressure loss curve.

Even though a parabolic inlet has been tested and found to exhibit excellent properties as explained above, any rounded, elliptical or chamfered inlet will exhibit better properties than an angular inlet. Rounded inlets have been tested both with regard to flow and cavitation.

The experiments carried out, and the accurate correlations that have been developed, facilitate accurate prediction of the flow capacity of any diameter of orifice. Therefore the required selection of diameters for inhibitor injection can be made for any petroleum field that the valve is to be used for. Modification of flow capacity with temperature different from that tested (6-20° C.) can be accounted for.

Likewise the required operation envelope (minimum inlet pressure, maximum pressure difference) is given by known cavitation characteristics.

Also limits for production of solids can be predicted based on the corrosion and erosion experiments and transformation to field specific solid particle size distribution.

In addition to the application as a dosage valve for inhibitors, the valve can also be adapted for use as a choke valve for different types of liquids.

What is claimed is:

1. A valve for dosing inhibitors into a flow of liquid through a pipeline wherein a liquid has a first and higher pressure upstream of the valve and a second and lower pressure downstream of the valve, the valve having a valve body with at least one orifice therethrough, the orifice having a substantially uniform diameter, through which orifice the liquid is adapted to flow, the orifice having an upstream inlet part, characterized in that the upstream inlet part has an enlarged diameter relative to the substantially uniform diameter of the orifice.

2. The valve according to claim 1, characterized in that the upstream inlet part is a shape selected from a group consisting of rounded, parabolic and chamfered.

3. The valve according to claim 1, characterized in that the upstream inlet part has a largest diameter at least 20% greater than a smallest diameter of the orifice.

4. The valve according to claims 1, characterized in that the ratio between a smallest diameter of the orifice and the diameter of a pipe of a group selected from a group consisting of an inlet pipe and an outlet pipe, is between 0,05 and 0,17.

5. The valve according to claim 1, characterized in that the inlet part has a largest diameter about twice a smallest diameter of the orifice.

6. The valve according to claim 1, characterized in that the length of the upstream inlet part is about half the diameter of the orifice.

7. A valve, especially for dosing inhibitors into a flow through a pipeline whereby a liquid has a first and higher pressure upstream of the valve and a second and lower pressure downstream of the valve, the valve having a valve body with at a plurality of orifices therethrough, through which orifices the liquid is adapted to flow, characterized in that the plurality of orifices are parallel.

8. The valve according to claim 7, characterized in that the valve body is disc shaped and rotatable about an axis transverse to the plane of the disc and that the orifices are distributed equidistant from the axis of rotation, so that a selected orifice can be rotated into a flow channel for the inhibitor.

9. The valve according to claim 7, characterized in that the plurality of orifices range from a diameter of about 3 mm to a diameter of about 10 mm.

10. The valve according to claim 7, characterized in that at least two orifices are adapted to be placed in parallel or in series in the flow.

11. The valve according to claim 7, characterized in that the ratio between the length of the orifice and the diameter of the orifice is between 8 and 30.

12. A method for flow control through an orifice characterized in forming the inlet of the orifice with an enlarged diameter relative to the remaining part of the orifice, to reduce the pressure drop immediately after the inlet and obtain a lowest pressure at the outlet side of the orifice.

13. The method according to claim 12, characterized in forming the inlet with a parabolic shape.
